(19) United States
(12) Patent Application Publication
(10) Pub. No.: US 2003/0084066 A1
(43) Pub. Date: May 1, 2003

(54) Device and method for assisting knowledge engineer in associating intelligence with content

(76) Inventors: Scott A. Waterman, Campbell, CA (US); Max Copperman, Santa Cruz, CA (US); Scott B. Huffman, Redwood City, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/004,264

(22) Filed: Oct. 31, 2001

(51) Int. Cl. G06F 7/00

(52) U.S. Cl. 707/104.1

(57) ABSTRACT

This document discusses, among other things, systems and methods for assisting a knowledge engineer in associating intelligence with content. An example system classifies a set of documents to concept nodes in a knowledge map that includes multiple taxonomies. A candidate feature extractor automatically extracts features from the documents. The candidate features are displayed with other information on a user-interface (UI). The other displayed information may include information regarding how relevant terms are to various concept nodes; such information may be obtained from a prior classification iteration. From the candidate features and accompanying information and/or personal knowledge, a knowledge engineer selects features and assigns the selected features to concept nodes. The documents are classified using the user-selected features and corresponding concept node assignments. The UI also indicates how successfully particular documents were classified, and displays the features and relevance information for the knowledge engineer to review. The knowledge engineer may alternatively select a subset of documents; the features of the subset are used to classify the documents.

### FIELD OF THE INVENTION

This document relates generally to, among other things, computer-based content provider systems and methods and specifically, but not by way of limitation, to device and method for assisting a knowledge engineer in associating intelligence with content.

### BACKGROUND

A computer network, such as the Internet or World Wide Web, typically serves to connect users to the information, content, or other resources that they seek. Web content, for example, varies widely both in type and subject matter. Examples of different content types include, without limitation: text documents; audio, visual, and/or multimedia data files. A particular content provider, which makes available a predetermined body of content to a plurality of users, must steer a member of its particular user population to relevant content within its body of content.

For example, in an automated customer relationship management (CRM) system, the user is typically a customer of a product or service who has a specific question about a problem or other aspect of that product or service. Based on a query or other request from the user, the CRM system must find the appropriate technical instructions or other documentation to solve the user's problem. Using an automated CRM system to help customers is typically less expensive to a business enterprise than training and providing human applications engineers and other customer service personnel. According to one estimate, human customer service interactions presently cost between $15 and $60 per customer telephone call or e-mail inquiry. Automated Web-based interactions typically cost less than one tenth as much, even when accounting for the required up-front technology investment.

One ubiquitous navigation technique used by content providers is the Web search engine. A Web search engine typically searches for user-specified text, either within a document, or within separate metadata associated with the content. Language, however, is ambiguous. The same word in a user query can take on very different meanings in different context. Moreover, different words can be used to describe the same concept. These ambiguities inherently limit the ability of a search engine to discriminate against unwanted content. This increases the time that the user must spend in reviewing and filtering through the unwanted content returned by the search engine to reach any relevant content. As anyone who has used a search engine can relate, such manual user intervention can be very frustrating. User frustration can render the body of returned content useless even when it includes the sought-after content. When the user's inquiry is abandoned because excess irrelevant information is returned, or because insufficient relevant information is available, the content provider has failed to meet the particular user's needs. As a result, the user must resort to other techniques to get the desired content. For example, in a CRM application, the user may be forced to place a telephone call to an applications engineer or other customer service personnel. As discussed above, however, this is a more costly way to meet customer needs.

To increase the effectiveness of a CRM system or other content provider, intelligence can be added to the content. In one example in which the content is primarily documents, a human knowledge engineer can create an organizational structure for documents. Then, each document in the body of documents can be classified according to the most pertinent concept or concepts represented in the document. However, both creating the organizational structure and/or classifying the documents presents an enormous task for a knowledge engineer, particularly for a large number of concepts or documents. For these and other reasons, the present inventors have recognized the existence of an unmet need to provide tools and techniques for assisting a knowledge engineer in the challenging task of associating intelligence with content. This, in turn, will enable a user to more easily navigate to the particular desired content.

### SUMMARY

This document discusses, among other things, systems and methods for assisting a knowledge engineer in associating intelligence with content. An example system classifies a set of documents to concept nodes in a knowledge map that includes multiple taxonomies. A candidate feature extractor automatically extracts features from the documents. The candidate features are displayed with other information on a user-interface (UI). The other displayed information may include information regarding how relevant terms are to various concept nodes; such information may be obtained from a prior classification iteration. From the candidate features and accompanying information and/or personal knowledge, a knowledge engineer selects features and assigns the selected features to concept nodes. The documents are classified using the user-selected features and corresponding concept node assignments. The UI also indicates how successfully particular documents were classified, and displays the features and relevance information for the knowledge engineer to review. The knowledge engineer may alternatively select a subset of documents; the features of the subset are used to classify the documents.

In one example, this document describes a system to assist a user in classifying documents to concepts. In this example, the system includes a user interface device. The user interface devices includes an output device configured to provide a user at least one term from a document and corresponding relevance information indicating whether the term is likely related to at least one concept. The user interface device also includes an input device configured to receive from the user first assignment information indicating whether the term should be assigned to the at least one concept for classifying documents to the at least one concept.

In another example, this document describes a method of assisting a user in classifying documents to concepts. The method includes providing a user at least one term from a document and corresponding relevance information indicating whether the term is likely related to at least one concept. The method also includes receiving from the user first assignment information indicating whether the term should be assigned to the at least one concept for classifying documents to the at least one concept.

In a further example, this document describes a system to assist a user in classifying a document, in a set of documents, to at least one node, in set of nodes, in a taxonomy in a set of multiple taxonomies. A candidate feature extractor includes input receiving the set of documents and an output providing candidate features extracted automatically from the document without human intervention. A user-selected feature/node list includes those candidate features that have been selected by the user and assigned to nodes in the multiple taxonomies for use in classifying the documents to the nodes. A user interface is provided to output the nodes and candidate features, and to receive user-input selecting and assigning features to corresponding nodes for inclusion in the user-selected feature/node list. A document classifier is coupled to receive the user-selected feature/node list to classify the documents to the nodes in the multiple taxonomies.

In yet another example, this document describes a method of extracting automatically candidate features from a set of documents, outputting to a user an indication of the candidate features, outputting to the user an indication of relevance of the candidate features to nodes, receiving user input providing user-selection of features and user-assignments of these features to nodes, and classifying documents to nodes in multiple taxonomies using the user-selected features and corresponding user-assignments. Other aspects of the present systems and methods will become apparent upon reading the following detailed description and viewing the accompanying drawings that form a part thereof.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a block diagram illustrating generally one example of a content provider illustrating how a user is steered to content.

FIG. 2 is an example of a knowledge map.

FIG. 3 is a schematic diagram illustrating generally one example of portions of a document-type knowledge container.

FIG. 4 is a block diagram illustrating generally one example of a system for assisting a knowledge engineer in associating intelligence with content.

FIG. 5 is a flow chart illustrating generally one example of a technique for using a system to assist a knowledge engineer in associating intelligence with content.

FIG. 6 is a flow chart illustrating generally another example of a technique for using a system to assist a knowledge engineer in associating intelligence with content.

FIG. 7 is a flow chart illustrating generally one example of an automated technique for providing analysis of document classification results to provide information to a knowledge engineer, such as to suggest which terms might be appropriate for associating with particular concept node(s) for tagging documents to the concept nodes.

FIG. 8 is a block diagram illustrating generally one example of a display or other output portion of a user interface of a system, which displays or otherwise outputs information for a knowledge engineer.

FIG. 9 is an example of a portion of a computer monitor screen image, from one implementation of a portion of a display of a user interface, which lists a number of taxonomies for which the system has provided some analysis after performing a document classification.

FIG. 10 is an example of a portion of another computer monitor screen image of a display, in which a knowledge engineer has followed one of the taxonomy links of FIG. 9 to a list of corresponding concept node links.

FIG. 11 is an example of a portion of another computer monitor screen image of a display, in which the knowledge engineer has followed one of the concept node links of FIG. 10.

FIG. 12 is an example of a portion of another computer monitor screen image of a display, which includes a display of “fallout” terms that were not assigned to any concept node in the particular taxonomy being evaluated.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents. In this document, the terms “a” or “an” are used, as is common in patent documents, to include one or more than one. Furthermore, all publications, patents, and patent documents referred to in this document are incorporated by reference herein in their entirety, as though individually incorporated by reference. In the event of inconsistent usages between this documents and those documents so incorporated by reference, the usage in the incorporated reference(s) should be considered supplementary to that of this document; for irreconciliable inconsistencies, the usage in this document controls.

Some portions of the following detailed description are presented in terms of algorithms and symbolic representations of operations on data bits within a computer memory. These algorithmic descriptions and representations are the ways used by those skilled in the data processing arts to most effectively convey the substance of their work to others skilled in the art. An algorithm includes a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

### Top-Level Example of Content Provider

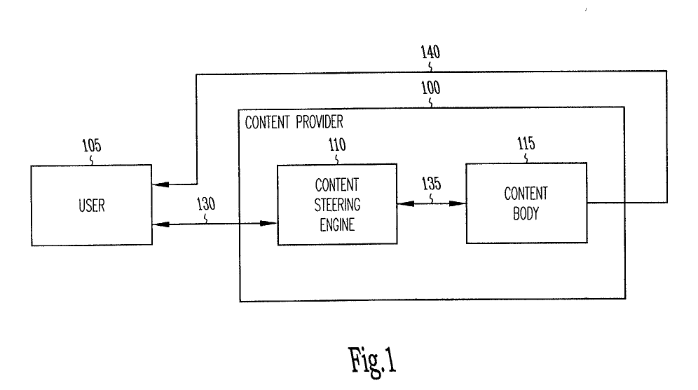

FIG. 1 is a block diagram illustrating generally one example of a content provider 100 system illustrating generally how a user 105 is steered to content. In this example, user 105 is linked to content provider 100 by a communications network, such as the Internet, using a Web-browser or any other suitable access modality. Content provider 100 includes, among other things, a content steering engine 110 for steering user 105 to relevant content within a body of content 115. In FIG. 1, content steering engine 110 receives from user 105, at user interface 130, a request or query for content relating to a particular concept or group of concepts manifested by the query. In addition, content steering engine 110 may also receive other information obtained from the user 105 during the same or a previous encounter. Furthermore, content steering engine 110 may extract additional information by carrying on an intelligent dialog with user 105, such as described in commonly assigned Fratkina et al. U.S. patent Ser. No. 09/798,964 entitled “A SYSTEM AND METHOD FOR PROVIDING AN INTELLIGENT MULTI-STEP DIALOG WITH A USER,” filed on Mar. 6, 2001, which is incorporated by reference herein in its entirety, including its description of obtaining additional information from a user by carrying on a dialog.

In response to any or all of this information extracted from the user, content steering engine 110 outputs at 135 indexing information relating to one or more relevant pieces of content, if any, within content body 115. In response, content body 115 outputs at user interface 140 the relevant content, or a descriptive indication thereof, to user 105. Multiple returned content “hits” may be unordered or may be ranked according to perceived relevance to the user's query. One embodiment of a retrieval system and method is described in commonly assigned Copperman et al. U.S. patent application Ser. No. 09/912,247, entitled SYSTEM AND METHOD FOR PROVIDING A LINK RESPONSE TO INQUIRY, filed Jul. 23, 2001, which is incorporated by reference herein in its entirety, including its description of a retrieval system and method. Content provider 100 may also adaptively modify content steering engine 110 and/or content body 115 in response to the perceived success or failure of a user's interaction session with content provider 100. One such example of a suitable adaptive content provider 100 system and method is described in commonly assigned Angel et al. U.S. patent application Ser. No. 09/911,841 entitled “ADAPTIVE INFORMATION RETRIEVAL SYSTEM AND METHOD,” filed on Jul. 23, 2001, which is incorporated by reference in its entirety, including its description of adaptive response to successful and nonsuccessful user interactions. Content provider 100 may also provide reporting information that may be helpful for a human knowledge engineer {“KE”) to modify the system and/or its content to enhance successful user interaction sessions and avoid nonsuccessful user interactions, such as described in commonly assigned Kay et al. U.S. patent application Ser. No. 09/911,839 entitled, “SYSTEM AND METHOD FOR MEASURING THE QUALITY OF INFORMATION RETRIEVAL,” filed on Jul. 23, 2001, which is incorporated by reference herein in its entirety, including its description of providing reporting information about user interactions.

### Overview of Example CRM Using Taxonomy-Based Knowledge Map

The system discussed in this document can be applied to any system that assists a user in navigating through a content base to desired content. A content base can be organized in any suitable fashion. In one example, a hyperlink tree structure or other technique is used to provide case-based reasoning for guiding a user to content. Another implementation uses a content base organized by a knowledge map made up of multiple taxonomies to map a user query to desired content, such as discussed in commonly assigned Copperman et al. U.S. patent application Ser. No. 09/594,083, entitled SYSTEM AND METHOD FOR IMPLEMENTING A KNOWLEDGE MANAGEMENT SYSTEM, filed on Jun. 15, 2000 (Attorney Docket No. 07569-0013), which is incorporated herein by reference in its entirety, including its description of a multiple taxonomy knowledge map and techniques for using the same.

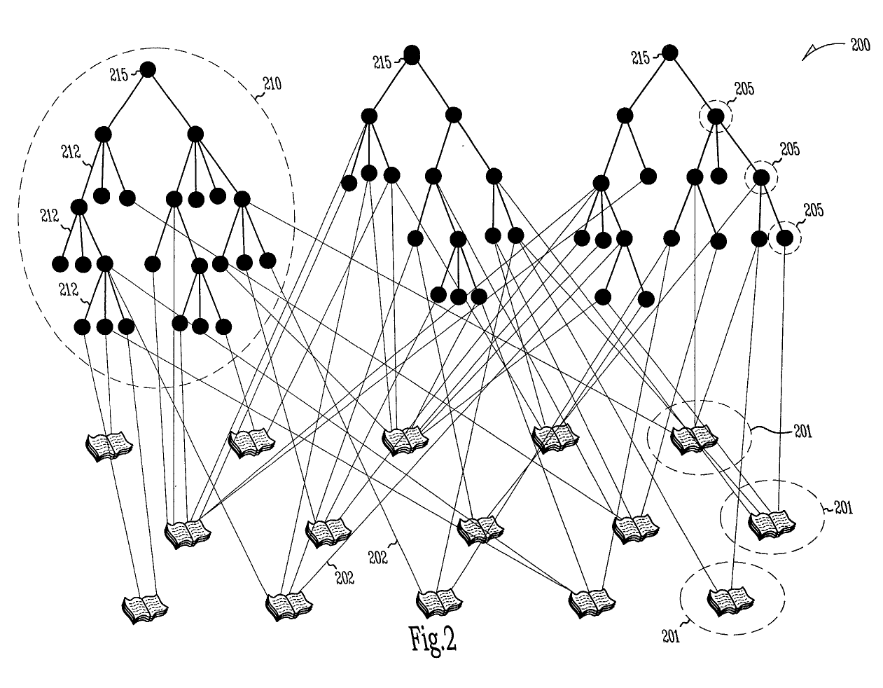

As discussed in detail in that document (with respect to a CRM system) and incorporated herein by reference, and as illustrated here in the example knowledge map 200 in FIG. 2, documents or other pieces of content (referred to as knowledge containers 201) are mapped by appropriately-weighted tags 202 to concept nodes 205 in multiple taxonomies 210 (i.e., classification systems). Each taxonomy 210 is a directed acyclical graph (DAG) or tree (i.e., a hierarchical DAG) with appropriately-weighted edges 212 connecting concept nodes to other concept nodes within the taxonomy 210 and to a single root concept node 215 in each taxonomy 210. Thus, each root concept node 215 effectively defines its taxonomy 210 at the most generic level. Concept nodes 205 that are further away from the corresponding root concept node 215 in the taxonomy 210 are more specific than those that are closer to the root concept node 215. Multiple taxonomies 210 are used to span the body of content (knowledge corpus) in multiple different orthogonal ways.

As discussed in U.S. patent application Ser. No. 09/594,083 and incorporated herein by reference, taxonomy types include, among other things, topic taxonomies (in which concept nodes 205 represent topics of the content), filter taxonomies (in which concept nodes 205 classify metadata about content that is not derivable solely from the content itself), and lexical taxonomies (in which concept nodes 205 represent language in the content). Knowledge container 201 types include, among other things: document (e.g., text); multimedia (e.g., sound and/or visual content); e-resource (e.g., description and link to online information or services); question (e.g., a user query); answer (e.g., a CRM answer to a user question); previously-asked question (PQ; e.g., a user query and corresponding CRM answer); knowledge consumer (e.g., user information); knowledge provider (e.g., customer support staff information); product (e.g., product or product family information). It is important to note that, in this document, content is not limited to electronically stored content, but also allows for the possibility of a human expert providing needed information to the user. For example, the returned content list at 140 of FIG. 1 herein could include information about particular customer service personnel within content body 115 and their corresponding areas of expertise. Based on this descriptive information, user 105 could select one or more such human information providers, and be linked to that provider (e.g., by e-mail, Internet-based telephone or videoconferencing, by providing a direct-dial telephone number to the most appropriate expert, or by any other suitable communication modality).

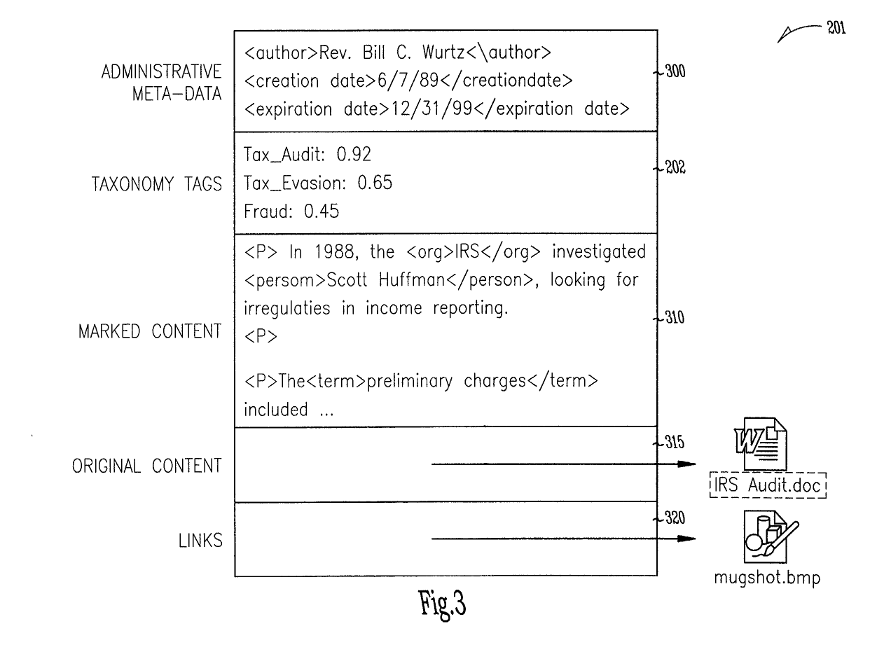

FIG. 3 is a schematic diagram illustrating generally one example of portions of a document-type knowledge container 201. In this example, knowledge container 201 includes, among other things, administrative metadata 300, contextual taxonomy tags 202, marked content 310, original content 315, and links 320. Administrative metadata 300 may include, for example, structured fields carrying information about the knowledge container 201 (e.g., who created it, who last modified it, a title, a synopsis, a uniform resource locator (URL), etc. Such metadata need not be present in the content carried by the knowledge container 201. Taxonomy tags 202 provide context for the knowledge container 201, i.e., they map the knowledge container 201, with appropriate weighting, to one or more concept nodes 205 in one or more taxonomies 210. Marked content 310 flags and/or interprets important, or at least identifiable, components of the content using a markup language (e.g., hypertext markup language (HTML), extensible markup language (XML), etc.). Original content 315 is a portion of an original document or a pointer or link thereto. Links 320 may point to other knowledge containers 201 or locations of other available resources.

U.S. patent application Ser. No. 09/594,083 also discusses in detail techniques incorporated herein by reference for, among other things: (a) creating appropriate taxonomies 210 to span a content body and appropriately weighting edges in the taxonomies 210; (b) slicing pieces of content within a content body into manageable portions, if needed, so that such portions may be represented in knowledge containers 201; (c) autocontextualizing the knowledge containers 201 to appropriate concept node(s) 205 in one or more taxonomies, and appropriately weighting taxonomy tags 202 linking the knowledge containers 201 to the concept nodes 205; (d) indexing knowledge containers 201 tagged to concept nodes 205; (e) regionalizing portions of the knowledge map based on taxonomy distance function(s) and/or edge and/or tag weightings; and (f) searching the knowledge map 200 for content based on a user query and returning relevant content.

It is important to note that the user's request for content need not be limited to a single query. Instead, interaction between user 105 and content provider 100 may take the form of a multi-step dialog. One example of such a multi-step personalized dialog is discussed in commonly assigned Fratkina et al. U.S. patent application Ser. No. 09/798,964 entitled, A SYSTEM AND METHOD FOR PROVIDING AN INTELLIGENT MULTI-STEP DIALOG WITH A USER, filed on Mar. 6, 2001 (Attorney Docket No. 07569-0015), the dialog description of which is incorporated herein by reference in its entirety. That patent document discusses a dialog model between a user 105 and a content provider 100. It allows user 105 to begin with an incomplete or ambiguous problem description. Based on the initial problem description, a “topic spotter” directs user 105 to the most appropriate one of many possible dialogs. By engaging user 105 in the appropriately-selected dialog, content provider 100 elicits unstated elements of the problem description, which user 105 may not know at the beginning of the interaction, or may not know are important. It may also confirm uncertain or possibly ambiguous assignment, by the topic spotter, of concept nodes to the user's query by asking the user explicitly for clarification. In general, content provider 100 asks only those questions that are relevant to the problem description stated so far. Based on the particular path that the dialog follows, content provider 100 discriminates against content it deems irrelevant to the user's needs, thereby efficiently guiding user 105 to relevant content. In one example, the dialog is initiated by an e-mail inquiry from user 105. That is, user 105 sends an e-mail question or request to CRM content provider 100 seeking certain needed information. The topic spotter parses the text of the user's e-mail and selects a particular entry-point into a user-provider dialog from among several possible dialog entry points. The CRM content provider 100 then sends a reply e-mail to user 105, and the reply e-mail includes a hyperlink to a web-browser page representing the particularly selected entry-point into the dialog. The subsequent path taken by user 105 through the user-provider dialog is based on the user's response to questions or other information prompts provided by CRM content provider 100. The user's particular response selects among several possible dialog paths for guiding user 105 to further provider prompts and user responses until, eventually, CRM system 100 steers user 105 to what the CRM system 100 determines is most likely to be the particular content needed by the user 105.

For the purposes of the present document, it is important to note that the dialog interaction between user 105 and content provider 100 yields information about the user 105 (e.g., skill level, interests, products owned, services used, etc.). The particular dialog path taken (e.g., clickstream and/or language communicated between user 105 and content provider 100) yields information about the relevance of particular content to the user's needs as manifested in the original and subsequent user requests/responses. Moreover, interactions of user 105 not specifically associated with the dialog itself may also provide information about the relevance of particular content to the user's needs. For example, if user 105 leaves the dialog (e.g., using a “Back” button on a Web-browser) without reviewing content returned by content provider 100, an nonsuccessful user interaction (NSI) may be inferred. In another example, if user 105 chooses to “escalate” from the dialog with automated content provider 100 to a dialog with a human expert, this may, in one embodiment, be interpreted as an NSI. Moreover, the dialog may provide user 105 an opportunity to rate the relevance of returned content, or of communications received from content provider 100 during the dialog. As discussed above, one or more aspects of the interaction between user 105 and content provider 100 may be used as a feedback input for adapting content within content body 115, or adapting the way in which content steering engine 110 guides user 105 to needed content.

### Example of System Assisting in Associating Intelligence with Content

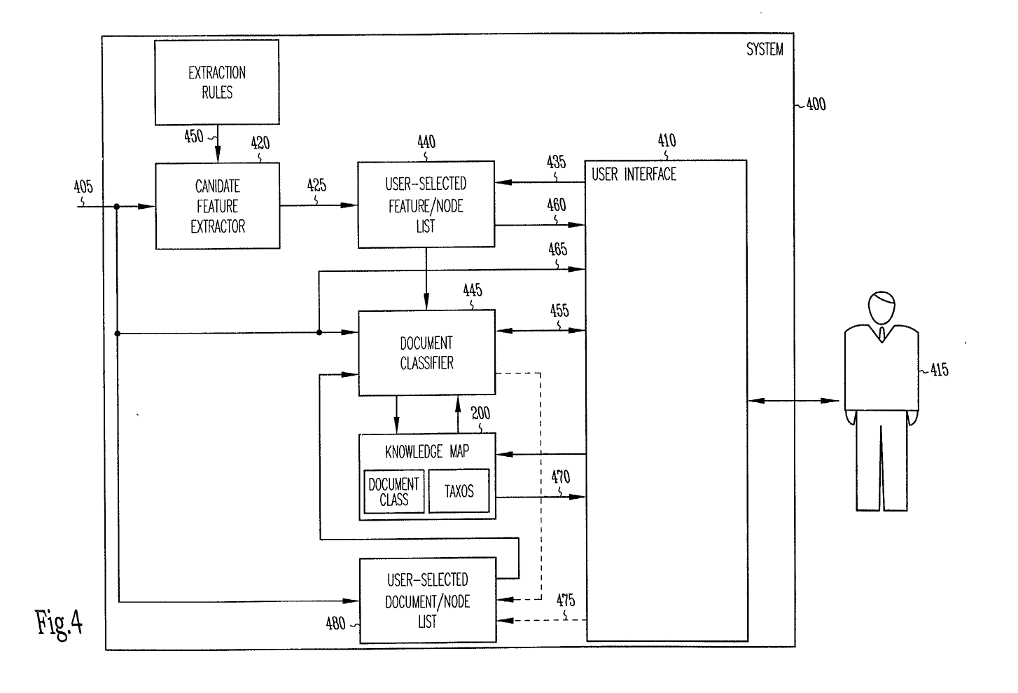

FIG. 4 is a block diagram illustrating generally one example of a system 400 for assisting a knowledge engineer in associating intelligence with content. In the example of system 400 illustrated in FIG. 4, the content is organized as discussed above with respect to FIGS. 2 and 3, for being provided to a user such as discussed above with respect to FIG. 1. System 400 includes an input 405 that receives body of raw content. In a CRM application, the raw content body is a set of document-type knowledge containers (“documents”), in XML or any other suitable format, that provide information about an enterprise's products (e.g., goods or services). System 400 also includes a graphical or other user input/output interface 410 for interacting with a knowledge engineer 415 or other human operator.

In FIG. 4, a candidate feature selector 420 operates on the set of documents obtained at input 405. Without substantial human intervention, candidate feature selector 420 automatically extracts from a document possible candidate features (e.g., text words or phrases; features are also interchangably referred to herein as “terms”) that could potentially be useful in classifying the document to one or more concept nodes 205 in the taxonomies 210 of knowledge map 200. The candidate features from the document(s), among other things, are output at node 425.

Assisted by user interface 410 of system 400, a knowledge engineer 415 selects at node 435 particular features, from among the candidate features or from the knowledge engineer's personal knowledge of the existence of such features in the documents; these user-selected features are later used in classifying (“tagging”) documents to concept nodes 205 in the taxonomies 210 of knowledge map 200. A feature typically includes any word or phrase in a document that may meaningfully contribute to the classification of the document to one or more concept nodes. The particular features selected by the knowledge engineer 415 from the candidate features at 425 (or from personal knowledge of suitable features) are stored in a user-selected feature/node list 440 for use by document classifier 445 in automatically tagging documents to concept nodes 205. For tagging documents, classifier 445 also receives taxonomies 210 that are input from stored knowledge map 200.

In one example, as part of selecting particular features from among the candidate features or other suitable features, the knowledge engineer also associates the selected features with one or more particular concept nodes 205; this correspondence is also included in user-selected feature/node list 440, and provided to document classifier 445. Alternatively, system 400 also permits knowledge engineer 415 to manually tag one or more documents to one or more concept nodes 205 by using user interface 410 to select the document(s) and the concept node(s) to be associated by a user-specified tag weight. This correspondence is included in user-selected document/node list 480, and provided to document classifier 445. As explained further below, user interface 410 performs one or more functions and/or provides highly useful information to the knowledge engineer 415, such as to assist in tagging documents to concept nodes 205, thereby associating intelligence with content.

In one example, candidate feature extractor 420 extracts candidate features from the set of documents using a set of extraction rules that are input at 450 to candidate feature selector 420. Candidate features can be extracted from the document text using any of a number of suitable techniques. Examples of such techniques include, without limitation: natural language text parsing, part-of-speech tagging, phrase chunking, statistical Markoff modeling, and finite state approximations. One suitable approach includes a pattern-based matching of predefined recognizable tokens (for example, a pattern of words, word fragments, parts of speech, or labels (e.g., a product name)) within a phrase. Candidate feature selector 420 outputs at 425 a list of candidate features, from which particular features are selected by knowledge engineer 415 for use by document classifier 445 in classifying documents.

Candidate feature selector 420 may also output other information at 425, such as additional information about these terms. In one example, candidate feature selector 420 individually associates a corresponding “type” with the terms as part of the extraction process. For example, a capitalized term appearing in surrounding lower case text may be deemed a “product” type, and designated as such at 425 by candidate feature selector 420. In another example, candidate feature selector 420 may deem an active verb term as manifesting an “activity” type. Other examples of types include, without limitation, objects, symptoms, etc. Although these types are provided as part of the candidate feature extraction process, in one example, they are modifiable by the knowledge engineer via user interface 410.

In classifying documents, document classifier 445 outputs edge weights associated with the assignment of particular documents to particular concept nodes 205. The edge weights indicate the degree to which a document is related to a corresponding concept node 205 to which it has been tagged. In one example, a document's edge weight indicates: how many terms associated with a particular concept node appear in that document; what percentage of the terms associated with a particular concept node appear in that document; and/or how many times such terms appear in that document. Although document classifier automatically assigns edge weights using these techniques, in one example, the automatically-assigned edge weights may be overridden by user-specified edge weights provided by the knowledge engineer. The edge weights and other document classification information is stored in knowledge map 200, along with the multiple taxonomies 210. One example of a device and method(s) for implementing document classifier 445 is described in commonly assigned Ukrainczyk et al. U.S. patent application Ser. No. 09/864,156, entitled A SYSTEM AND METHOD FOR AUTOMATICALLY CLASSIFYING TEXT, filed on May 25, 2001, which is incorporated herein by reference in its entirety, including its disclosure of a suitable example of a text classifier.

Document classifier 445 also provides, at node 455, to user interface 410 an set of evidence lists resulting from the classification. This aggregation of evidence lists describes how the various documents relate to the various concept nodes 205. In one example, user-interface 410 organizes the evidence lists such that each evidence list is associated with a corresponding document classified by document classifier 445. In this example, a document's evidence list includes, among other things, those user-selected features from list 440 that appear in that particular document. In another example, user-interface 410 organizes the evidence lists such that each evidence list is associated with a corresponding concept node to which documents have been tagged by document classifier 445. In this example, a concept node's evidence list includes, among other things, a list of the terms deemed relevant to that particular concept node, a list of the documents in which such terms appear, and respective indications of how frequently a relevant term appears in each of the various documents. In addition to the evidence lists, classifier 445 also provides to user interface 410, among other things: the current user-selected feature list 440, at 460; links to the documents themselves, at 465; and representations of the multiple taxonomies, at 470.

### Overview of Example Techniques for Classifying Documents

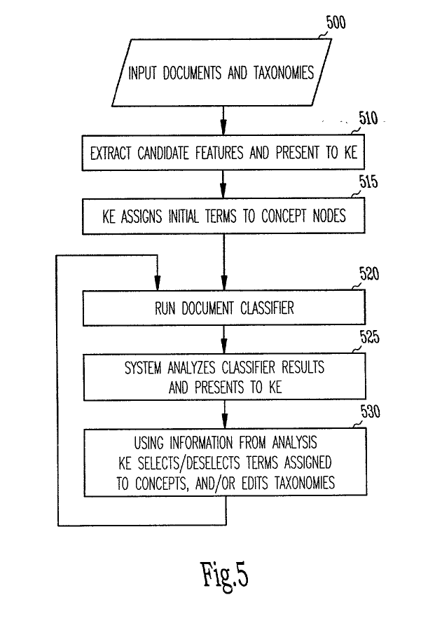

FIG. 5 is a flow chart illustrating generally one example of a technique for using system 400 to assist a knowledge engineer (“KE”) 415 in associating intelligence with content. At 500, documents and taxonomies 210 are input into system 400. At 510, candidate feature extractor 420 is run to extract candidate features (and associated feature types, if any). User interface 410 displays or otherwise outputs this information for the knowledge engineer 415. At 515, the knowledge engineer 415 initially assigns particular terms/features to particular concept nodes 205. As an illustrative example, for a taxonomy 210 pertaining to colors, and having two concept nodes 205, “BLUE” and “RED,” the knowledge engineer 415 may assign candidate text terms “blue” and “indigo” to the “BLUE” concept node, and assign the candidate text terms “red” and “maroon” to the “RED” concept node. If the knowledge engineer 415 is aware of a particular term that is suitable for being assigned to a particular concept node, the knowledge engineer may make such an assignment without actually selecting that term from the list of candidate features provided by candidate feature extractor 425.

A document will be tagged to a concept node 205 based on whether (and/or to what extent) its assigned term(s) are found in that document. A concept node 205, therefore, may have a list of one or several relevant assigned terms deemed useful by the knowledge engineer 415 for classifying documents to that concept node 205. When a candidate feature is so assigned to a concept node 205, system 400 also places the selected feature and associated concept node 205 onto user-selected feature/node list 440 for use in later classifying documents to concept nodes 205.

In the example of FIG. 5, at 520, document classifier 445 is run. This classifies documents to concept nodes 205 in taxonomies 215 using the terms/features selected by the knowledge engineer 415 and assigned to particular concept nodes 205. The document classification at 520 results in information that relates particular documents to particular concept nodes 205. In one example, document classifier 445 provides, among other things, an evidence list corresponding to each document. In this example, the document's evidence list indicates the concept nodes 205 to which that document relates. The document's evidence list may include, among other things, edge weight(s) from the document to particular concept node(s) 205. Such edge weights indicate the degree to which a document relates to a corresponding concept node 205. In an alternative example, the evidence lists are organized by concept node 205, rather than by document, so as to indicate the document(s) to which a particular concept node 205 relates.

At 525, system 400 analyzes the results of the classification performed at 520 by document classifier 445, organizes the analysis, and presents the analysis results to the knowledge engineer 415 through user interface 410. In one example, the analysis results are presented to a knowledge engineer 415 in such a way as to suggest to the knowledge engineer 415 particular terms that are likely related to particular concept nodes 205. Examples of statistical or other analysis functions and the presentation of their results to the knowledge engineer 415 through user interface 410, is discussed in more detail below. At 530, using such provided information, the knowledge engineer 415 assigns relevant terms to concept nodes 205, deassigns irrelevant terms from concept nodes 205, and/or reassigns terms to other concept nodes 205, as the knowledge engineer 415 deems appropriate. This improves the effectiveness of the document classification performed at 520, which may then be reiterated one or more times after 530, as illustrated in FIG. 5. Additionally (or alternatively) at 530, the knowledge engineer 415 may edit one or more taxonomies 415, such as to add, delete, move, or reweight concept nodes 205.

FIG. 5 illustrates an example of some human intervention at 530 by the knowledge engineer 515. The knowledge engineer 415 evaluates the results of the automated statistical or other analysis at 525 of the document classification at 520. The knowledge engineer uses human judgement to accordingly adjust the terms assigned to concept nodes 205 for subsequently remapping the documents to the concept nodes 205. This likely provides at least some advantage over a completely automated system in which predefined rules are applied to the results of the automated analysis at 525 to automatically adjust the terms assigned to concept nodes 205 for then remapping the documents to the concept nodes 205. For example, in a taxonomy 210 for identifying industry types in newswire articles, one might find that “Germany” and/or the names of German cities correlate highly with documents relating to the pharmaceutical industry. However, an automated rule that would assign the term “Germany” to a concept node “PHARMACEUTICAL” in a taxonomy of “INDUSTRY-TYPE,” based on the high statistical correlation therebetween, could result in a subsequent document classification that erroneously tags many irrelevant documents to the “PHARMACEUTICAL” concept node merely because these documents contain the term “Germany,” which is logically distinct from the industry type. By contrast, a human knowledge engineer 415 would understand this logical distinction, and could therefore opt not to assign the term “Germany” to the concept node “PHARMACEUTICAL” in a taxonomy pertaining to industry-type.

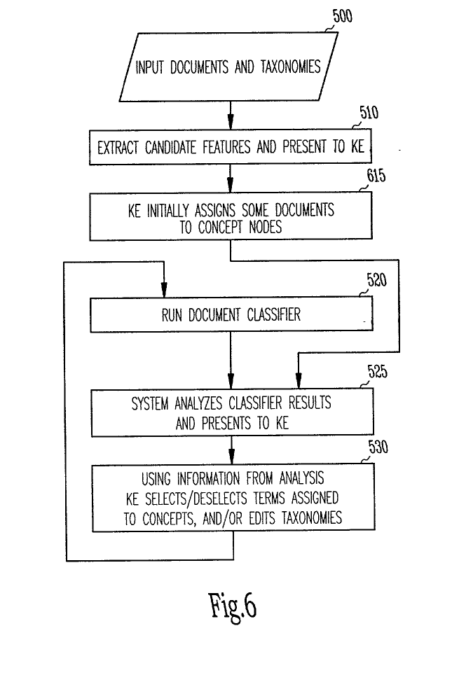

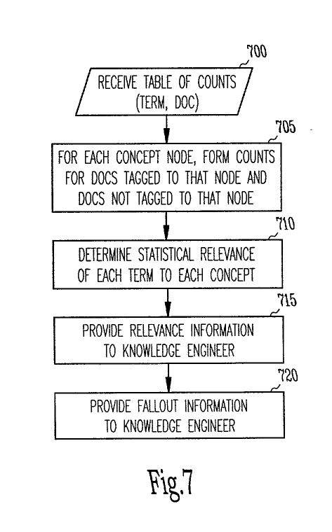

FIG. 6 is a flow chart illustrating generally another example of a technique for using system 400 to assist the knowledge engineer 415 in associating intelligence with content. FIG. 6 is similar in some respects to FIG. 5, however, at 615 (corresponding to 515, of FIG. 5), the knowledge engineer 415 initially assigns (by providing user-input at 475) some documents to particular concept nodes 205 to which these documents relate; an indication of this correspondence relationship between document and concept node 205 is stored in user-selected document/node list 480. Then, using the edge weights assigned by the knowledge engineer 415 to the subset of documents, process flow continues at 525 to provide analysis results to the knowledge engineer 415. This includes suggesting terms from the subset of documents and providing information regarding the relevance of these terms to various concept nodes 205, as discussed further below with respect to FIG. 7. Then, at 530, the knowledge engineer 415 then assigns (or deassigns) terms to concept nodes 205. Then, at 520, the document classifier is run on all the other documents in the set of documents input at 405. The results may again be presented at 525 to the knowledge engineer 415 for further refinement, at 530, of the assignment of terms to concept nodes 205.

### Example of Analysis Techniques For Suggesting Terms

At 525 of FIGS. 5 and 6, system 400 performed at least some automated statistical or other analysis of the results of the document classification at 520. FIG. 7 is a flow chart illustrating generally an example of an automated technique for providing such analysis of the document classification results, such as to provide information to a knowledge engineer 415 suggesting which terms might be appropriate to assign to particular concept nodes 205 for tagging documents to the concept nodes 205.

In the example FIG. 7, at 700 document classifier 445 outputs a count for each assigned term (associated with concept node(s) 205) and the document(s) in which that term appears. Each count is therefore a function of a term and a document (e.g., Count (Term, Document)=CountValue), and its count value indicates how many times that term appeared in that document. At 705, for each concept node 205 in a taxonomy 215, the Counts are summed to form counts for: (1) those documents tagged to that concept node 205; and (2) those documents not tagged to that concept node 205. For example, a set of concept nodes C1, C2, C3, etc. may relate to a set of documents D1, D2, D3, etc. by corresponding tag weights W1, W2, W3, etc., as follows:

C1 (W1, W5, W10);

C2 (W1, W2, W3);

C3 (W2, W5, W11); etc.

In this example, C1 is related to documents D1, D5, and D10 by weights W1, W5, and W10; C2 is related to documents D1, D2, and D3 by weights W1, W2, and W3; and C3 is related to documents D2, D5, and D11 by weights W2, W5, and W11, etc. The tag weights may be binary-valued (e.g., 0 or 1), may be decimal values (e.g., 1, 3.5, 12.2, etc.), or may be normalized (e.g., to a decimal value between 0 and 1). At 705, for each concept node 205, system 400 computes a Count (Term, Concept) and a Count (Term, Not Concept). In the above example, for a term T1 tagged to concept node C1, system 400 computes Count (T1, C1)=Count (T1, D1)+Count (T1, D5)+Count (T1, D10). That is, system 400 computes Count (T1, C1) by summing the Counts for all documents tagged to concept node C1. Similarly, system 400 also computes a Count (T1, ˜C1) by summing the Counts for all documents that are not tagged to concept node C1.

At 710, system 400 uses the above-computed information to determine the statistical relevance of each term to each concept node 205. One illustrative method for computing and/or presenting statistical relevance information for the knowledge engineer 415 uses a 2×2 table of the relationship of each term to each concept node 205, as illustrated by Table 1 for term T1 and concept node C1.

TABLE 1

| | | |
|---|---|---|
| Relation Of C1 & T | T1 | ˜T1 (i.e., Not T1) |
| C1 | (T1, C1) | (˜T1, C1) |
| ˜C1 (i.e., Not C1) | (T1, ˜C1) | (˜T1, ˜C1) |

Using such information, system 400 tests whether T1 and C1 (and the other term/concept pairs) are statistically correlated, thereby indicating that the term is statistically related (relevant) to the concept node 205, or statistically independent, which indicates that the term is not statistically related or relevant to the concept node 205. Several statistical tests are suitable for this purpose (e.g., Person's Chi-square test, log-likelihood test, etc.) System 400 uses user interface 400 to present such statistical relevance information at 715 to the knowledge engineer 415. This effectively suggests to the knowledge engineer 415, based on a statistical likelihood of relevance, which terms should be considered for being assigned to which concept nodes for subsequently classifying documents.

Because the document classification at 520 may have resulted in some documents that were not successfully classified to any concept nodes 205, such “fallout” information may also be presented at 720 to the knowledge engineer 415 via user interface 400. Such fallout information includes, among other things, a document-by-document count of the fallout terms that did not classify to any concept node 205, and/or a sum of the fallout terms over all fallout documents. In one example, providing fallout information to the knowledge engineer 415 includes providing links into the fallout documents so that the knowledge engineer 415 may display the text of such documents to determine which, if any, terms in that document may be useful in classifying that document into one or more concept nodes 205. Alternatively, the knowledge engineer 415 may then edit the taxonomies 210, such as to add one or more concept nodes 205, and to assign relevant terms to these new concept nodes 205, so that the fallout documents will subsequently tag appropriately to such concepts 205.

### Examples of Information Displayed By User Interface

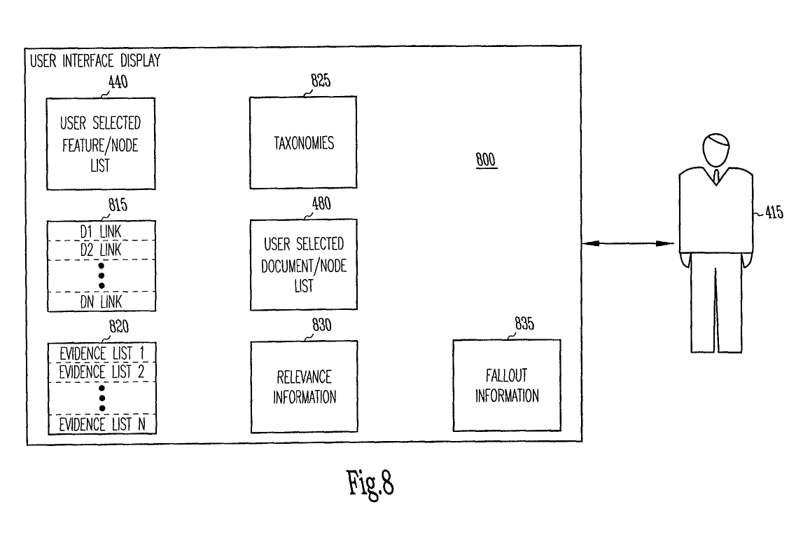

FIG. 8 is a block diagram illustrating generally one example of a display 800, or other output portion of user interface 410 of system 400, which displays or otherwise outputs information for a knowledge engineer 415, such as: the present user-selected feature/node list 440; links to the documents (e.g., D1, D2, . . . , DN) 815 and their corresponding evidence lists (e.g., Evidence List 1, Evidence List 2, . . . , Evidence List N) 820 of tag weight(s) from the document to various concept nodes 205; representations of the multiple taxonomies 825 (and their concept nodes 205); the present user-selected document/node list 480 (if the user manually tagged selected documents to concept nodes 205); the statistical relevance information 830 for various terms; and the fallout information 835 about documents that failed to classify to any concept nodes 205. This information permits analysis by the knowledge engineer 415.

In one example, the individual document links 815 and corresponding evidence lists 820 are ordered or ranked according to how successfully the document was tagged by document classifier 445 to the various concept nodes 205 in the multiple taxonomies 210. For example, documents that were tagged to more concept nodes 205 may be ordered to be displayed before other documents that were tagged to a lesser number of concept nodes 205. This allows the knowledge engineer 415 to evaluate those documents that were tagged to few concept nodes 205, or that failed to tag to any concept nodes 205 altogether. This allows the knowledge engineer 415 to select a link associated with a poorly-tagged document, bringing up that document for display. The display of that document may further highlight its features/terms from its corresponding evidence list, so that the knowledge engineer 415 can view these features in context with the other text or features of that document. In a further example, a representation 825 of the multiple taxonomies 210 in the knowledge map 200 is also displayed, highlighting those concept nodes 205 to which the document under examination was tagged.

With this information, the knowledge engineer 415 is better able to diagnose the reason that the document was poorly tagged. The knowledge engineer 415 can then respond appropriately to improve the document's tagging during subsequent reclassification by document classifier 445. In one example, the knowledge engineer 415 can examine candidate features of the poorly tagged document and select additional feature(s) to be added to the user-selected feature/node list 440, and can also establish or remove correspondence (e.g., initial tag weights) between particular features and particular concept nodes 205. The knowledge engineer 415 may also (or alternatively) edit the taxonomies 210, for example, by adding additional concept nodes 205 to an existing taxonomy 210, or by adding new taxonomies to the multiple taxonomies 210 that form knowledge map 200.

User interface display 800 may also compute and display additional statistics to assist the knowledge engineer 415 in the above-described tasks. Examples of such displayed statistics include, without limitation: the number of occurrences of a particular feature (or group of features) in documents tagged to a particular concept node 205 (or group of concept nodes 205); the number of occurrences of the feature(s) in all documents; the number of associations of the feature(s) with all taxonomies 210, or with particular taxonomies 210; and/or any of the analytical information discussed above with respect to FIG. 7.

After the knowledge engineer 415 edits the feature/node list 440 or taxonomies 210, as discussed above, the set of documents is reclassified, and the results of the reclassification may be displayed to the knowledge engineer 415, as discussed above. Further iterations of edits by the knowledge engineer 415 and classifications by document classifier 445 may be carried out, as needed, to improve the manner in which the documents are tagged to the concept nodes 205 in the knowledge map 200. This process effectively associates intelligence with the content body 115 to better guide user 105 to the desired content.

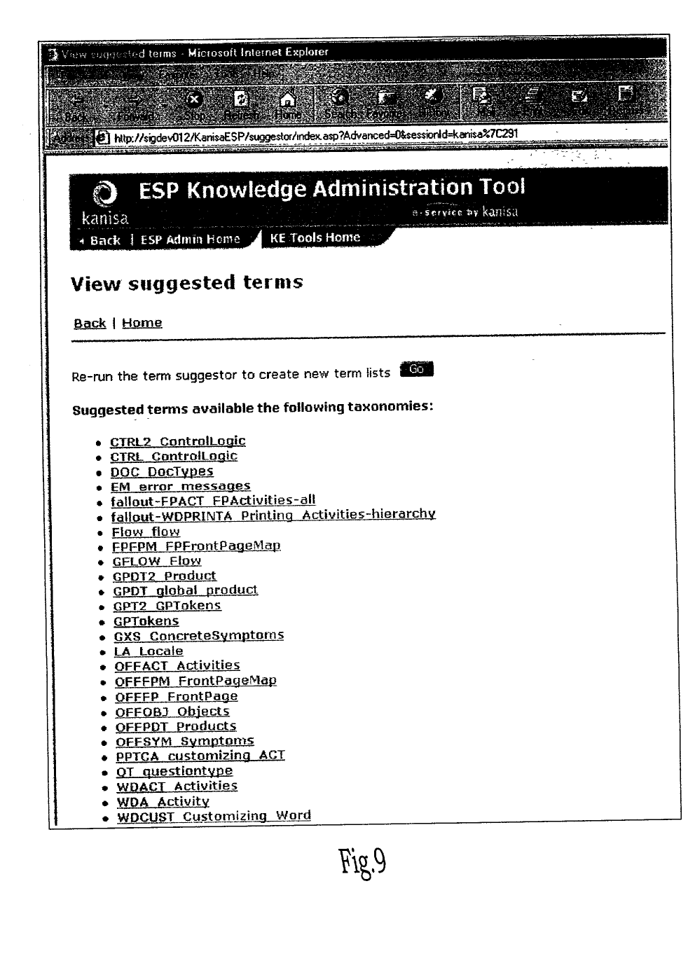

FIG. 9 is an example of a portion of a computer monitor screen image, from one implementation of a portion of display 800 of user interface 410, which lists a number of taxonomies 215 (e.g., CTRL2_ControlLogic, fallout-FPACT_FPActivities-all, etc.) for which system 400 has analyzed a previous document classification. The displayed taxonomy links connect the knowledge engineer 415 to other information about the taxonomies (e.g., structure, statistics, etc.). The displayed taxonomy links that are prefaced with the word “fallout” provide links to analysis for documents were not assigned to any concept node 205 in that taxonomy 210 by the document classifier 445. The knowledge engineer 415 can use this analysis to identify further terms in the fallout documents that might be useful in classifying the fallout documents (or other documents) to concept node(s) 205 in that taxonomy 210.

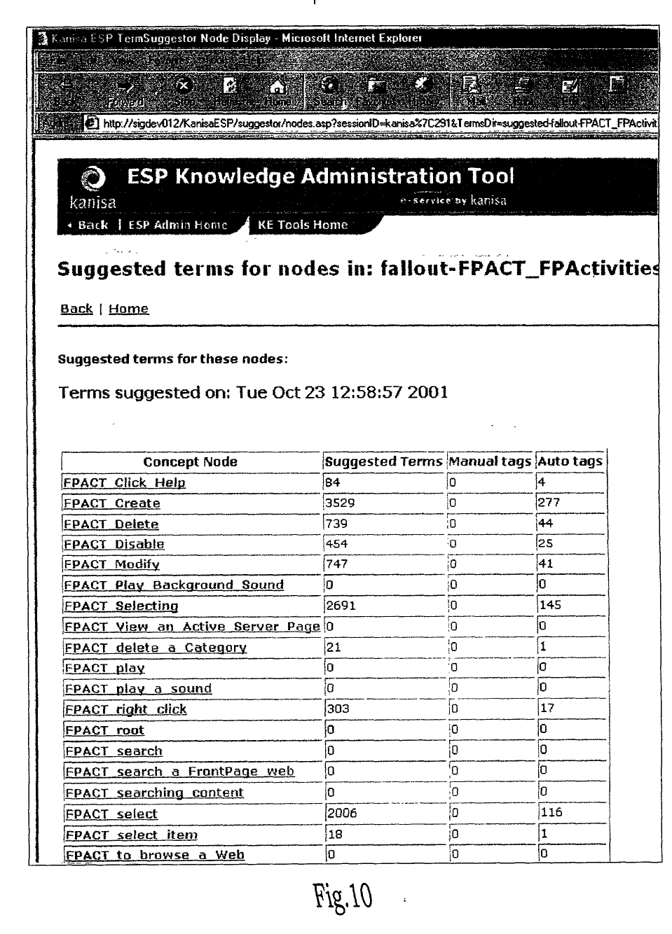

FIG. 10 is an example of a portion of another computer monitor screen image of display 800, in which the knowledge engineer 415 has followed one of the taxonomy links (i.e., “fallout-FPACT_FPActivities-all”) of FIG. 9 to a list of corresponding concept node links. FIG. 10 also displays suggested term/feature information (e.g., how many terms are statistically likely to be relevant to that concept node 205), manual tag information (e.g., how many documents were manually tagged by the knowledge engineer 415 to that concept node; in this particular example, these numbers are “0,” indicating that the corresponding documents were tagged to the concept node 205 by the document classifier 445 rather than by the knowledge engineer 415, however, this will not always be the case), and autotag information (e.g., how many documents were automatically tagged by document classifier 445 to that concept node 205).

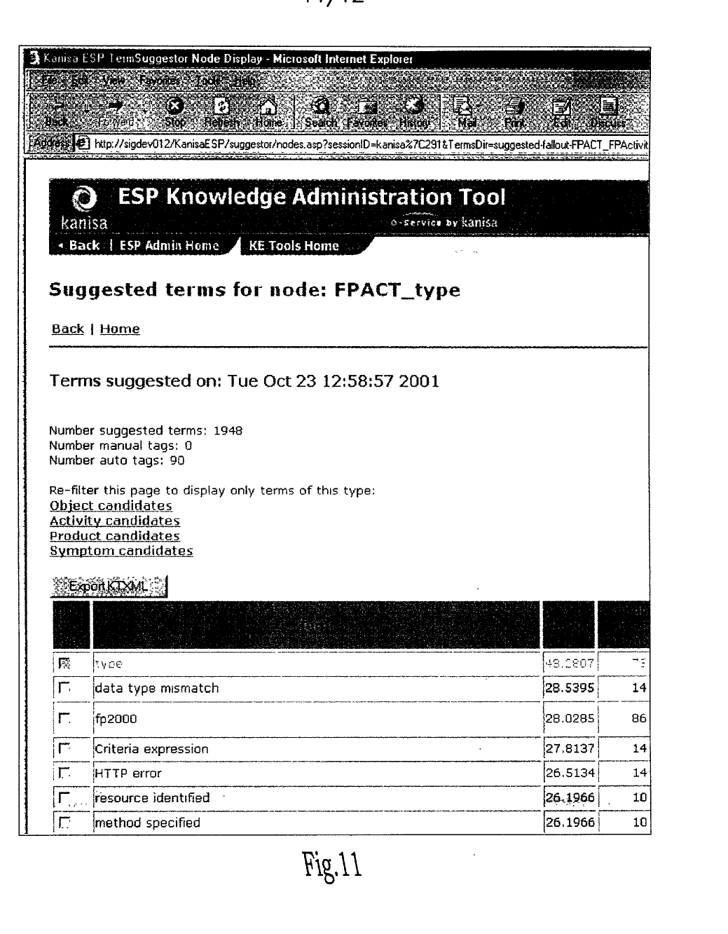

FIG. 11 is an example of a portion of another computer monitor screen image of display 800, in which the knowledge engineer 415 has followed one of the concept node links (i.e., “FPACT_type”) of FIG. 10. For that concept node 205, this example of display 800 lists terms that may be statistically relevant to that concept node 205, a weight or other indication of the statistical relevance of the term to that concept node 205, and a count of how many times the term appeared in documents that were tagged to that concept node 205 (or, alternatively, of how many documents tagged to that concept node 205 included that term). This is one example of how system 400 suggests candidate terms/features to the knowledge engineer 415 for being associated with a particular concept node 205. The knowledge engineer 415 can select particular suggested terms by clicking on a corresponding box displayed to the left of the term. The displayed term is then “greyed out” to indicate that the term has been assigned to the concept node 205 for carrying out a subsequent document classification.

FIG. 11 also illustrates one example of why human input is helpful in more accurately associating intelligence with content. In this example, the concept node “FPACT_type” pertains to the activity of typing on a keyboard, and is used in a knowledge map 200 in an automated CRM system 100 for providing information about a particular software package. One of the terms that is statistically suggested as being relevant to the concept of the user activity of typing is the phrase “data type mismatch,” which includes the word “type.” A human knowledge engineer 415 would understand, however, that the term “data type mismatch” is logically distinct from the user activity of typing at a keyboard. Therefore, the knowledge engineer 415 would, for example, not select “data type mismatch” to be associated with the concept “FPACT_type.” This avoids subsequently erroneously tagging documents including the term “data type mismatch” to the concept node “FP_ACT_type.” In another example, the knowledge engineer 415 could explicitly assign the term “data type mismatch” to a more appropriate concept node 205. In a further example, the knowledge engineer 415 could modify the properties of the term “data type mismatch” so that document classifier 445 does not break up this longer phrase into its constituent words (e.g., (“data” and “type” and “mismatch”), which is what results in the misclassification. In general, by assisting the knowledge engineer 415 in more accurately associating intelligence with content, a user 105 of content provider 100 can more easily request and navigate to the desired content.

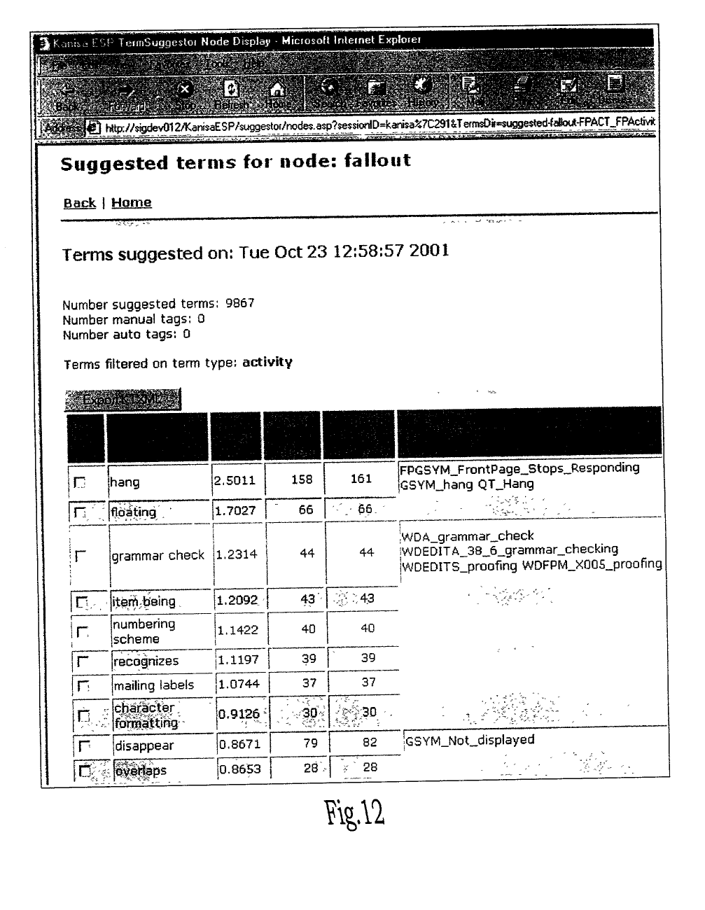

FIG. 12 is an example of a portion of another computer monitor screen image of display 800, which includes a display of terms in “fallout” documents that were not assigned to any concept node 205 in the particular taxonomy 210 being evaluated. Moreover, in this example, such terms in the “fallout” documents have been filtered according to a particular “type” attribute assigned to the feature during the automatic candidate feature extraction by candidate feature selector 420. In this example, only features of “activity” type are being displayed. In FIG. 12, the displayed information includes a list of the terms in the fallout documents. For each such term, there is provided statistical weight information about each such term's relevance to a hypothetical concept node 205 to which all of the “fallout” documents would be tagged, a count of the number of documents including the term (“Count Across Taxonomy”), a count of the number of fallout documents including the term (“Count in Concept”), and a list of the concept nodes 205 in this or other taxonomies to which the term is assigned.

Based on this information, the knowledge engineer 415 can assign term to an appropriate concept node 205 to reduce the number of fallout documents produced by a subsequent document classification by document classifier 445. This process by which the knowledge engineer 415 finds appropriate concepts 205 to which the terms are then assigned so as to reduce the number of fallout documents is helpful in expanding the range of mapped subject matter. This improves any subsequent document classification.

### CONCLUSION

In the above discussion and in the attached appendices, the term “computer” is defined to include any digital or analog data processing unit. Examples include any personal computer, workstation, set top box, mainframe, server, supercomputer, laptop or personal digital assistant capable of embodying the inventions described herein. Examples of articles comprising computer readable media are floppy disks, hard drives, CD-ROM or DVD media or any other read-write or read-only memory device.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein. Moreover, the terms “first,” “second,” and “third,” etc. are used merely as labels, and are not intended to impose numerical requirements on their objects.

What is claimed is:

1. A system to assist a user in classifying documents to concepts, the system including a user interface device, including an output device configured to provide a user at least one term from a document and corresponding relevance information indicating whether the term is likely related to at least one concept, the user interface device also including an input device configured to receive from the user first assignment information indicating whether the term should be assigned to the at least one concept for classifying documents to the at least one concept.

2. The system of claim 1, further including a document classifier, the document classifier including an input receiving the documents and the concepts, and including an output providing at least one classification of at least one of the documents to at least one of the concepts, the document classifier including instructions to be executed to classify the at least one document to the at least one concept by comparing terms in the documents to user-assigned terms assigned to the concepts.

3. The system of claim 2, further including a knowledge map including multiple taxonomies, each taxonomy including at least one concept node representing a particular concept.

4. The system of claim 1, further including a candidate features extractor, the candidate feature extractor including an input receiving the documents, the candidate feature extractor including an output, which is coupled to the user interface, the extractor output providing candidate terms from the documents from which the user can select at least one term to be assigned to at least one concept.

5. The system of claim 1, in which the user interface input device is also configured to receive from the user second assignment information indicating whether at least one document should be assigned to at least one concept for extracting terms from the at least one document from which the user can select at least one term to be assigned to the at least one concept for classifying documents to the at least one concept.

6. The system of claim 1, in which the output device includes a taxonomy display listing taxonomies for which at least one term and corresponding relevance information is available.

7. The system of claim 1, in which the output device includes a concept node display listing concept nodes for which at least one term and corresponding relevance information is available.

8. The system of claim 1, in which the output device includes a term display listing at least one term and corresponding relevance information.

9. A method of assisting a user in classifying documents to concepts, the method including:
providing a user at least one term from a document and corresponding relevance information indicating whether the term is likely related to at least one concept; and
receiving from the user first assignment information indicating whether the term should be assigned to the at least one concept for classifying documents to the at least one concept.

10. The method of claim 9, further including assigning or deassigning the term to the at least one concept using the first assignment information, to provide at least one user-assigned term corresponding to the at least one concept.

11. The method of claim 10, further including classifying documents to concepts by comparing terms in the documents to the at least one user-assigned term.

12. The method of claim 11, further including computing the relevance information using results from the classifying documents to concepts.

13. The method of claim 9, further including forming multiple taxonomies for organizing concepts.

14. The method of claim 9, further including receiving from the user second assignment information indicating whether at least one document should be assigned to at least one concept.

15. The method of claim 14, further including extracting terms from the at least one document from which the user can select at least one term to be assigned to the at least one concept for classifying documents to the at least one concept.

16. The method of claim 9, further including providing the user information about taxonomies for which at least one term and corresponding relevance information is available.

17. The method of claim 9, further including providing the user information about concept nodes for which at least one term and corresponding relevance information is available.

18. A system to assist a user in classifying a document, in a set of documents, to at least one node, in set of nodes, in a taxonomy in a set of multiple taxonomies, the system including:
a candidate feature extractor, including a n input receiving the set of documents and an output providing candidate features extracted automatically from the document without human intervention;
a user-selected feature/node list, including those candidate features that have been selected by the user and assigned to nodes in the multiple taxonomies for use in classifying the documents to the nodes;
a user interface, to output the nodes and candidate features, and to receive user-input selecting and assigning features to corresponding nodes for inclusion in the user-selected feature/node list; and
a document classifier, coupled to receive the user-selected feature/node list, to classify the documents to the nodes in the multiple taxonomies.

19. The system of claim 18, in which the document classifier includes:
a first input receiving the set of documents;
a second input receiving the user-selected feature/node list;
a third input receiving multiple taxonomies; and
an output providing, edge weights from the documents to the nodes.

20. The system of claim 18, in which the user interface outputs, for a document selected by the user, those features corresponding to that particular document.

21. The system of claim 18, in which the user interface outputs, for a document, a corresponding indicator of how successfully the document classifier classified the document to the nodes in the multiple taxonomies.

22. The system of claim 21, in which the user interface outputs a list of the documents ranked according to the number of nodes to which each document was classified by the document classifier.

23. The system of claim 18, in which the user-interface outputs a representation of the multiple taxonomies.

24. The system of claim 18, in which the document classifier includes a first input receiving a selected subset of the set of documents, each document in the subset assigned by the user to at least one node, and in which the document classifier classifies the set of documents to nodes in the multiple taxonomies using features of the selected subset of documents.

25. A method including:
extracting automatically candidate features from a set of documents;
outputting to a user an indication of the candidate features;
outputting to the user an indication of relevance of the candidate features to nodes;
receiving user input of user-selected features and user-assignments of the user-selected features to nodes; and
classifying documents to nodes in multiple taxonomies using the user-selected features and corresponding user-assignments.

26. The method of claim 25, further including providing, for each document, those features corresponding to that particular document.

27. The method of claim 15, including outputting an indication of how successfully a document was classified.

28. The method of claim 27, in which the outputting includes providing a list of the documents ranked according to the number of nodes to which each document was classified.

29. The method of claim 25, further including outputting a representation of the multiple taxonomies.

30. The method of claim 25, further including receiving user input of a user-selected subset of the set of documents, and wherein the receiving user input of user-selected features and user-assignments of the user-selected features to nodes is performed on features obtained from the user-selected subset of the documents.
